(19) United States
(12) Patent Application Publication
(10) Pub. No.: US 2013/0013616 A1
(43) Pub. Date: Jan. 10, 2013

(54) Systems and Methods for Natural Language Searching of Structured Data

(76) Inventors: Jochen Lothar Leidner, Zug (CH); Frank Schilder, Saint Paul, MN (US); Thomas Robert Zielund, Shakopee, MN (US); Isabelle Alice Yvonne Moulinier, Richfield, MN (US)

(21) Appl. No.: 13/178,924

(22) Filed: Jul. 8, 2011

(51) Int. Cl. G06F 17/30

(52) U.S. Cl. 707/742; 707/769; 707/E17.075

(57) ABSTRACT

The invention relates to searching structured data using natural language searches. More specifically and preferably, the invention relates to the use of an inverted file index built from generated documents to make data, typically unsearchable using a natural language search, searchable.

### FIELD OF THE INVENTION

The invention relates to searching structured data using natural language searches. More specifically, the invention relates to using data that is typically not searchable using a natural language search and making it searchable with a natural language search.

### BACKGROUND OF THE INVENTION

Often, when people have a topic to research, they turn to the internet. Through the internet, people may access search engines from many companies including Google, Microsoft, and others.

In order to research a given topic, people will typically perform a natural language or keyword search. A natural language search is a search wherein the searcher uses a regular spoken language, such as English, to enter a search. For example, the searcher may access www.google.com and enter “what is the best time to plant grass seed?” in the search box. This particular search returned over 1,000,000 results. Similarly, a keyword search is a search, not necessarily using regular spoken language (i.e., sentences), wherein at least one word is entered. Such a search may be used to attempt to find documents with at least one of the entered words. For example, the searcher may access www.google.com and enter “grass seed plant best time” in the search box. This particular search returned over 800,000 results.

As used herein, the term “natural language search” includes keyword searches. Searchers use search engines from Google, Microsoft, and various other companies to conduct natural language searches. It is noted that, as used herein, both the natural language searches and keyword searches do not include searches performed on entered words in a form wherein the searcher is limited to a particular set of words. For example, the website http://apartments.cazoodle.com permits one to search for apartments but only if the search is limited to, e.g., a city or state. A search for the term “three bedrooms” will not identify any results (instead, this type of search may be performed by using a pull-down menu on the website).

The results of natural languages searches are from unstructured data. As used herein, “data” includes any type of information and includes but is not limited to both numbers and text.

Differentiating between unstructured data and structured data is based upon whether the data is associated with a logical schema. Unstructured data is data unassociated with a logical schema. Structured data is data that is associated with a logical schema. Thus, unlike unstructured data, structured data is associated with a specification as to how the data may be found or located in an unambiguous manner. For example, a specification for a relational database table of ordered names, street addresses, towns, states, and zip codes would state that zip codes are found in column five (whereas names, street addresses, towns, and states are found in columns one, two three, and four, respectively). Examples of structured data include, but are not limited to relational databases (which use the Data Definition Language [DDL] for writing logical schema), XML databases (which use an XML schema to describe the structure of XML files and the types of the data contained therein) and spreadsheets (which provide a manner in which to accurately identify data stored within fixed fields within a record or file). Examples of unstructured data include, but are not limited to email messages, word processing documents, documents in .pdf format, web pages, and other types of data comprising free-form text. Thus, as mentioned above, the difference between structured data and unstructured data is that structured data is associated with a specification as to how data may be found or located in an unambiguous manner. This is why, for example, that although data in XML databases are not stored in fixed locations (as is the case with spreadsheets), XML data is still considered structured because it may be unambiguously identified (via, e.g., tags associated with the data).

Unfortunately, natural language search engines are ineffective at providing search results from structured data. This is problematic from a number of perspectives. For example, Google, provider of one of the most commonly used search engines, has admitted that it has “not been doing a good job” of presenting structured data found on the web to users. See www.readwriteweb.com/archives/google_were_not_doing_a_good_job with_structured_data.php. In this context, Google has difficulty providing search results which include content from the “deep web” (those internet resources that sit behind forms and site-specific search boxes and are unable to be indexed by passive means). Other search engines may face similar challenges. Google estimates the “deep web” to be about 500 times the size of the “shallow web” which is estimated to contain about 5 million web pages. Another example relates to information solutions providers, such as Thomson Reuters, which provides information solutions to workers in the healthcare, tax and accounting, legal, scientific, news/media and financial areas.

This problem is made more acute by the fact that people are becoming more and more accustomed to searching for information using natural language searches.

### SUMMARY OF THE INVENTION

We have realized that the use of text generation technology enhances the effectiveness of being able to search structured data using natural language searches. More specifically, our invention relates to computer implemented methods to respond to receiving a natural language search. This is done by searching a set of information searchable using the natural language search wherein the set of information was generated from a set of structured information which is unsearchable using the natural language search. Next, a set of search results is formulated and a signal associated with the set of search results is transmitted. Corresponding systems are also disclosed as are methods and systems for creating such information searchable via natural language searches.

Advantageously, the present invention permits the use of natural language searching on a set of information associated with structured data.

Also advantageously, the present invention permits the use of natural language searching using an inverted file index.

Other advantages of the present invention will be apparent to those skilled in the art from the remainder of this specification.

### BRIEF DESCRIPTION OF THE DRAWINGS

FIG. 1 shows a system in accordance with the present invention that may be used to generate a text collection and an inverted file index and also shows the resultant text collection and inverted file index;

FIG. 2 shows a flowchart detailing the operation of the system of FIG. 1 which may be done offline;

FIG. 3 shows an example of a document which is a portion of a text collection and was generated from a set of structured information;

FIG. 4 shows an example of an inverted file index; and

FIG. 5 shows a flowchart detailing the operation of the system of FIG. 5.

### DETAILED DESCRIPTION

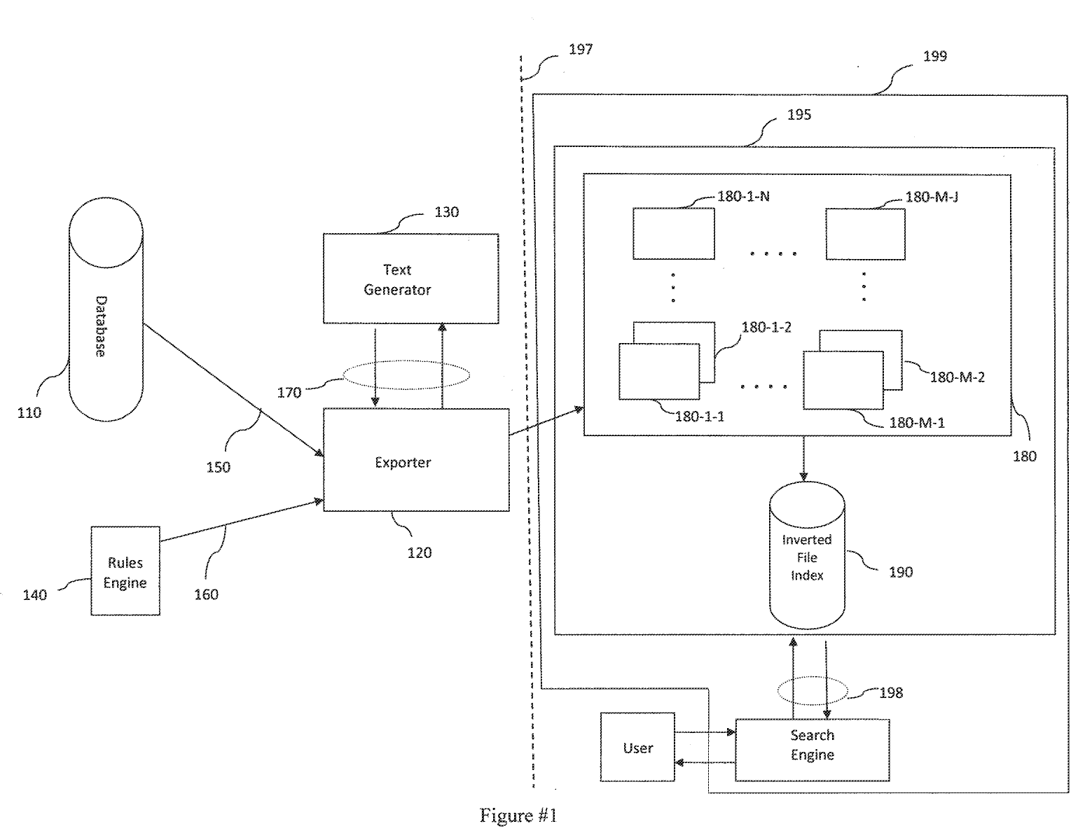

The system 100 of FIG. 1 comprises a database 110, an exporter 120, a text generator 130, and a rules engine 140, all of which may be implemented as combinations of hardware and software as will be appreciated by those skilled in the art. Text generators are known in the art. See, e.g., Dale, Robert and Reiter, Ehud, Building Natural Language Generation Systems (Cambridge University Press, Cambridge, U.K. 2000). The database 110 comprises structured data and is functionally connected to the exporter 120 via communications link 150. The exporter 120 is functionally connected to the rules engine 140 and the text generator 130 via communication links 160 and 170, respectively. Communication links 150, 160, and 170 may be a hardwired bus, a wireless link, or any other type of communications link, including optical links, software function calls, and the like, known to those skilled in the art.

Referring again to FIG. 1, system 100 is used to generate a text collection 180 and an inverted file index 190, both of which may be stored in memory 195. The system 100 may be used in an offline manner when generating the text collection 180 and the inverted filed index 190. Once generated and stored in memory 195, the manner in which memory 195 may be accessed is through the use of an online search using, e.g., natural language via communications link 198.

Referring yet again to FIG. 1, the portion of the system to the right of line 197, exclusive of any user equipment, is a system 199 that responds to natural language searches. More specifically, system 199 comprises memory 195 and search engine 198, along with other associated hardware and software to respond to natural language searches. Through the use of hardware and software, system 199 has a means for receiving a natural language search and a means for searching. An example of hardware and software that may be used to receive a natural language search and to conduct a search is a personal computer based on an Intel central processing unit (“CPU”). Other examples include a mobile computing device such as an Apple iPhone® or a Hadoop parallel computation cluster. System 199 also has, through the use of hardware and software, means for formulating a set of search results and means for transmitting a signal associated with the set of search results. An example of hardware and software that may be used for formulating a set of search results is the Apache Lucene full-text search engine. Other examples include both an inverted index managed by an Objective C indexing and retrieval library and the Glascow Terrier system. Additionally, an example of hardware and software that may be used to transmit a signal associated with the set of search results is a machine implementing any of the Hyper Text Transfer Protocol/Hyper Text Markup Language (“HTTP/HTML”), eXtensible Markup Language over HTTP (“XML-over-HTTP”) or Simple Object Access Protocol (“SOAP”).

Still referring to FIG. 1, the text collection 180 is comprised of multiple documents. The first set of documents, 180-1-1 through 180-1-N, relates to, e.g., a first spreadsheet having N records wherein each document (e.g., 180-1-3) has a corresponding record (e.g., record #3) within the first spreadsheet. Likewise, the last set of documents, 180-M-1 through 180-M-J, related to, e.g., the M^{th} spreadsheet having J records wherein each document (e.g., 180-M-4) has a corresponding record (e.g., record #4) within the M^{th} spreadsheet. Those skilled in the art will appreciate that each record within the database 110 will have a corresponding document (e.g., 180-17-23, corresponding to the 23^{rd} record of the 17^{th} spreadsheet [not shown]) in the text collection 180. Those skilled in the art will also appreciate that those elements to the right of line 197 are used in an online manner while those elements to the left of line 197 are used to generate the contents of memory 195 (e.g., the text collection 180 and the inverted file 190) in an offline fashion.

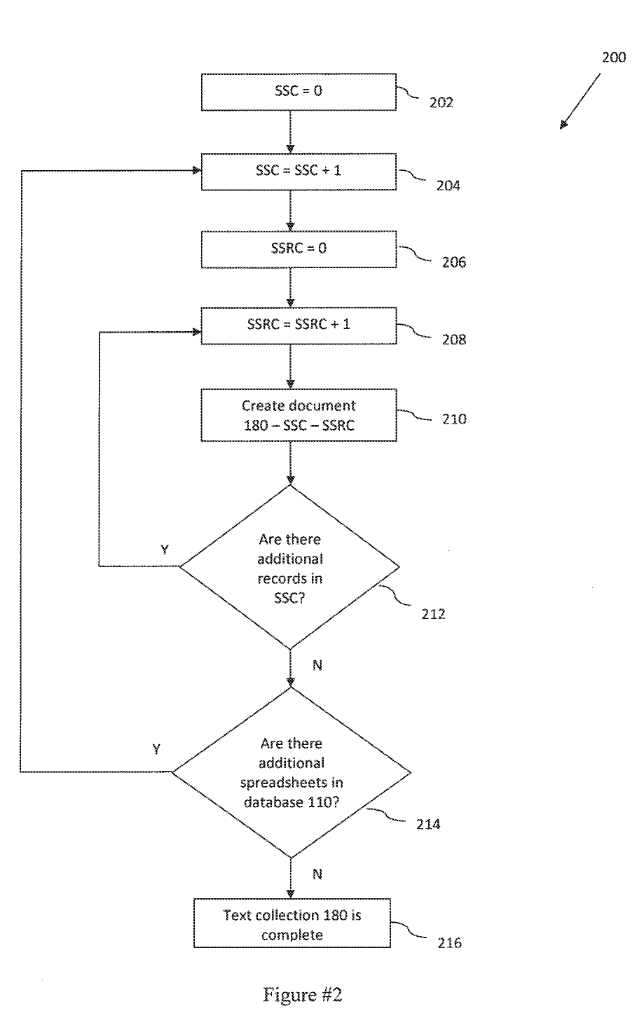

Referring to FIG. 2, a flowchart 200 is described detailing the operation of the components of system 100 and how they generate a text collection 180 and an inverted file 190. Assume, as in FIG. 1, that database 110 comprises various sets of structured information such as spreadsheets 1 through M. Further assume that spreadsheet 1 contains N records and spreadsheet M contains J records. To create a first document in text collection 180, a spreadsheet counter, SSC, is initialized to zero in step 202. Next SSC is incremented in step 204. Next, a spreadsheet record counter, SSRC, is initialized to zero in step 206 and then incremented in step 208. Next, in step 210, the exporter 120 reads record 1 of spreadsheet 1 and creates file 180-1-1 of text collection 180. Next, a portion of system 100 determines whether spreadsheet 1 contains additional records (see step 212). If so, the process goes to step 208 and SSRC is incremented. Otherwise, in step 214, the portion of the system determines whether there is an additional spreadsheet. If so, the process goes to step 204 and counter SSC is incremented. Otherwise, the text collection 180 is complete as shown in box 216. Those skilled in the art will realize that the above description of FIG. 2 may be done in an offline fashion. They will also realize that the example has been described with respect to sets of structured information that happen to be spreadsheets but the same could be done with any set or sets of structured information including but not limited to SQL databases, XML files, tab-separated text files, and graph stores.

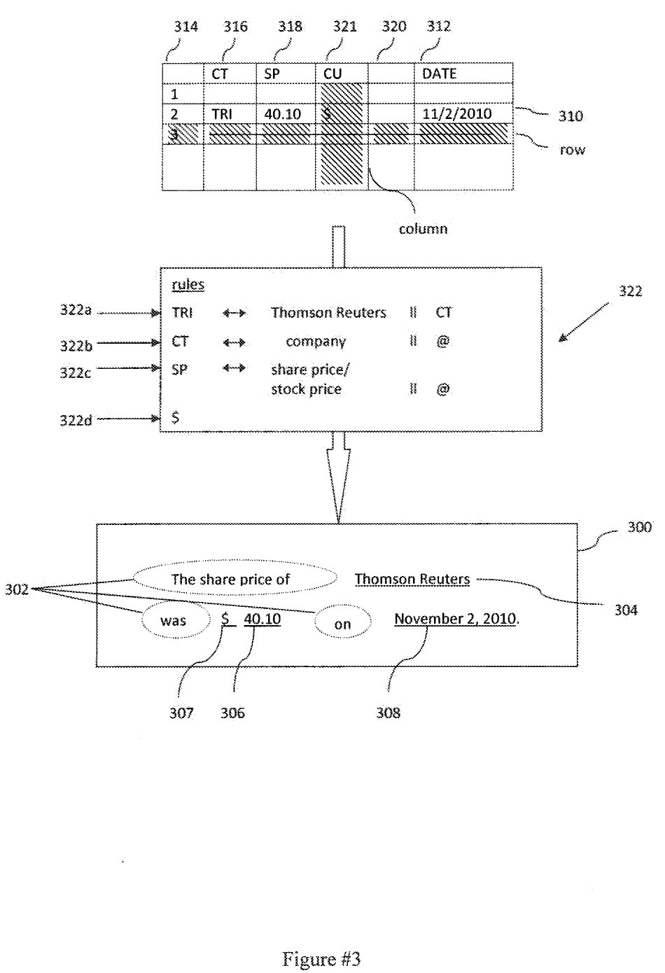

Again referring to FIG. 2, the relationship with FIG. 1 is described. There is one document for each row of the database 110. The exporter may be realized as a batch exporter, generating all documents offline and at once. It may also be realized as an incremental process, generating documents only as required (e.g., triggered by changes in the database 110). The exporter 120 communicates with the rules engine 140. Rules engine 140 has two sets of rules. The first set of rules specifies textual transformations. An example of a textual transformation is the expansion of a stock ticker symbol by the company name with which it is associated (e.g., substituting TRI with Thomson Reuters). The second set of rules represents language templates with placeholders. A completed example of this is shown as document 300 of FIG. 3. Instantiation of document 300 is discussed further below with reference to FIG. 3. The text generator 130 selects an appropriate template and instantiates the placeholders with the values from the current database row.

Referring to FIG. 3, an example of a document 300 which is a portion of a text collection 180 and was generated from a set of structured information is shown. The document 300 is comprised of a template portion 302 and placeholders 304, 306, and 308. In this particular example, the document 300 relates to stock prices on a particular day. The set of structured information used to generate the document 300 is shown in row 310 of the set of structured information 312. This set of structured information 312 has various records denoted by a row number (see column 314). Each record contains a company ticker symbol identified in column 316, a share price identified in column 318, a date identified in column 320, and a currency identified in column 321. A set of rules 322 is used to take entries in columns 316, 318, 320, and 321 and translate them into characters which will ultimately populate placeholders 304, 306, 308, and 307, respectively. Once complete, document 300 is referred to as being instantiated. More specifically, the set of rules 322 may be generated through human review of the set of structured information 312. After this review, the reviewer drafts particular rules (322a, 322b, 322c, and 322d) relating to the particular set of structured information (may need some additional examples/information/discussion on how these are generated). In this example, row 310 reflects that a stock with a ticker symbol “TRI” was sold for $40.10 on May 20, 1011. Rules engine 140 is applied to row 310 to generate a document 300 stating “[t]he share price of Thomson Reuters was $40.10 on Nov. 2, 2010.” This is accomplished by identifying where to insert, within a template stating “[t]he share price of (insert company name) was (insert currency) (insert amount) on (insert date),” particular fields of each record within database 110. This completes generation of document 300 which is part of text collection 180. It is noted that document 300 is searchable using a natural language search whereas the set of structured information 312 is not searchable using a natural language search.

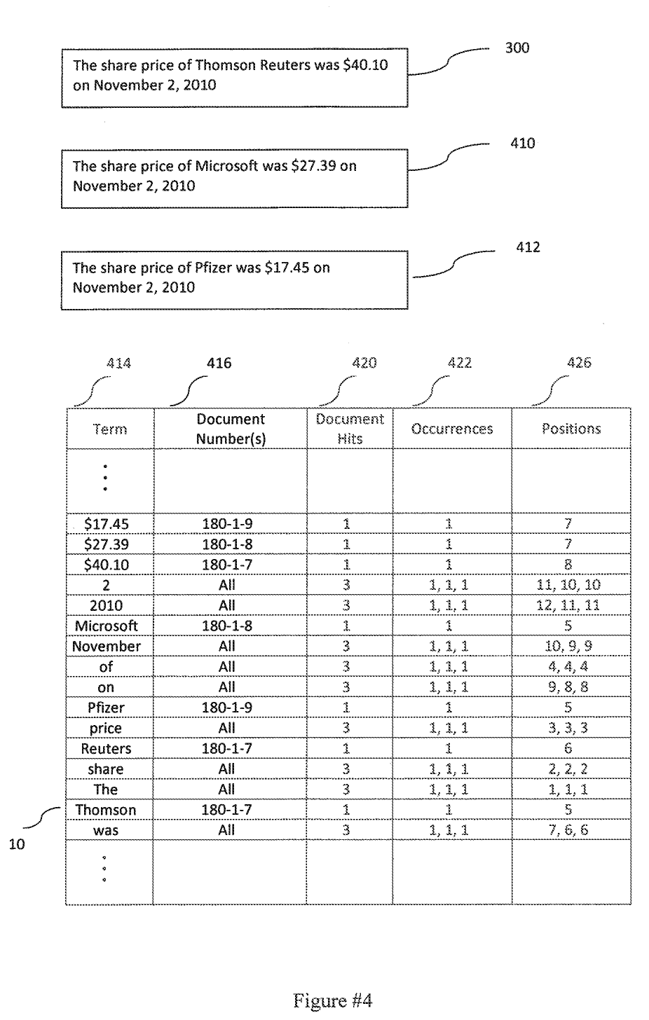

Referring to FIG. 4, an inverted file index 190 is shown. This particular inverted file index 190 relates to document 300 (repeated in FIG. 4 for convenience), document 410, and document 412. Documents 300, 410, and 412 relate to the share prices of Thomson Reuters, Microsoft, and Pfizer stocks as of Nov. 2, 2010. These documents are among many documents that may be part of, e.g., text collection 180. Assume documents 300, 410, and 412 correspond to documents bearing numbers 180-1-7, 180-1-8, and 180-1-9, respectively, of text collection 180. In other words, they are associated with, respectively, the 7^{th} through 9^{th} records of the first spreadsheet. In this example, the inverted file index 190 is comprised of a first column 414, a second column 416, a third column 420, a fourth column 422, and a fifth column 426. The first column 414 comprises a list, preferably alphabetically, of all terms within documents 300, 410, and 412. The second column comprises the document numbers relating to text collection 180. It should be noted that, for ease of reading, the word “All” has been substituted for the collection of documents 180-1-7, 180-1-8, and 180-1-9. Thus, by way of example, because the term “price” bears the entry “All” in the second column 416, it means that the term “price” appears in each of documents 180-1-7, 180-1-8, and 180-1-9. Similarly, because the term “Microsoft” bears the entry 180-1-8 in the second column 416, it means that the term “Microsoft” appears in document 180-1-8. The third column 420 comprises the number of “hits” for each term in the first column 414. For example, assuming that documents 180-1-7, 180-1-8, and 180-1-9 were the only documents in text collection 180, performing two separate natural language searches using the present invention for the terms “price” and “Pfizer” would return three documents (i.e., documents 180-1-7, 180-1-8, and 180-1-9) and one document (i.e., document 180-1-9), respectively. The fourth column 422 denotes the number of occurrences of each term. For example, Microsoft appears one time in document 180-1-8 whereas was appears one time in each of documents 180-1-7, 180-1-8, and 180-1-9. The fifth column 426 represents the position, in words, of each term in each document. For example, “Reuters ” is the sixth word in document 180-1-7 whereas “November” is the tenth, ninth, and ninth word, respectively, in documents 180-1-7, 180-1-8, and 180-1-9.

Again referring to FIG. 4, it will be apparent that the exemplary inverted file index 190 is both a record level inverted index and a word level inverted index because it comprises the second column 416 and the fifth column 426, respectively. It is apparent to those skilled in the art that, in general, an inverted file index 190 functions to map content, such as words, numbers, and other things searchable using natural languages searches, to structured data (e.g., XML databases). Thus, modifications to inverted file index 190 which would result in another inverted file index 190 include but are not limited to the removal of and/or addition of columns. As will be appreciated by those skilled in the art, database 110 will typically be comprised of many different sets of structured information comprising various records and fields. For example, some records may relate to restaurants in a particular zip code along with hours of operation whereas other records may relate to sales prices of television sets (arranged by, e.g., size, model number, manufacturer, technology type, etc . . . ) at particular stores. Thus, each record in database 110 will have a corresponding file within text collection 180 designated by one reference numeral ranging from 180-1-1 through 180-M-J.

Those skilled in the art will appreciate that the portion of the detailed description above, relating to the creation of an inverted file index and a system for the same, may be done in an offline fashion. However, in order to conduct a natural language search on a set of information associated with structured data, work must be done online.

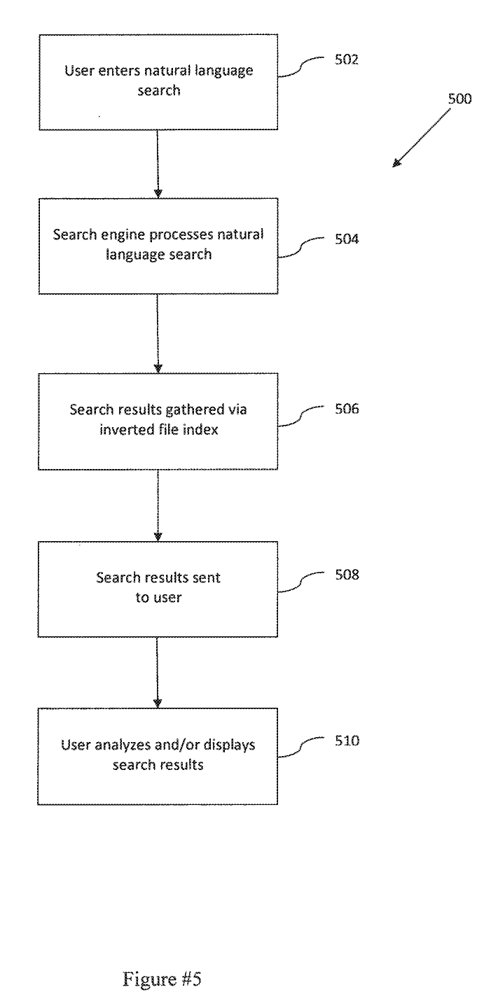

Referring to FIG. 5, a flowchart 500 detailing the operation of the portion of the system 100 to the right of line 197 is shown. First, in step 502 a user enters a natural language search. These searches may utilize ranked retrieval based on keywords or Boolean logic. Google, Bing, and Yahoo are examples of search engines wherein a user may conduct a natural language search. Second, in step 504 the natural language search is received by a search engine. Third, in step 506, a set of search results is gathered, formulated, and/or otherwise collected. The inverted file index 190 is used to perform this step. The set of search results gathered comprises various files within text collection 180. Fourth, in step 508, a signal associated with the set of search results is sent to the user. This signal, as will be appreciated by those skilled in the art, may be compressed or take on any format as long as a reasonable facsimile of particular document within the text collection may be reproduced for the user. Fifth and finally, in step 510, the user may analyze and/or display the set of search results (or reasonable facsimile thereof).

Those skilled in the art will realize that the detailed description above is provided for illustrative purposes and to enable those skilled in the art to make and use the claimed invention. For example, although the text collection 180 and inverted file index 190 are described in English, the invention may be used in any language. Additionally, although the present invention has been described with respect to financial information (e.g., stock prices), it may be used to make any structured data searchable using a natural language search. Further, there may be a set of templates used wherein each template, once completed, corresponds to a different instantiation of document 300 in a different language. Still further, although the present invention has been described as retrieving only search results that at one point were unsearchable using a natural language search, those skilled in the art will appreciate that the search results may also contain information, such as unstructured data, that was always searchable using a natural language search. Thus, the invention is defined by the appended claims.

1. A computer implemented method comprising:
a. receiving a natural language search;
b. in response to the natural language search, searching a set of information searchable using the natural language search, the set of information having been generated from a set of structured information which is unsearchable using the natural language search;
c. based upon the step of searching, formulating a set of search results; and
d. transmitting a signal associated with the set of search results.

2. The method of claim 1 wherein a language associated with the natural language search is English.

3. The method of claim 1 wherein a language associated with the natural language search is a language other than English.

4. The method of claim 1 wherein the set of information was generated by:
a. accessing the set of structured information; and
b. applying a text generator to the set of structured information.

5. The method of claim 4 wherein the text generator generates the set of information in multiple languages.

6. The method of claim 4 wherein the text generator generates the set of information in English.

7. A computer implemented method comprising:
a. identifying a set of structured information wherein the set of structured information is unsearchable using a natural language search;
b. based upon the set of structured information, generating an additional set of information wherein the additional set of information is searchable using the natural language search.

8. The method of claim 7 wherein the step of generating comprises using a text generator and a rules engine.

9. The method of claim 8 wherein the additional set of information comprises a text collection.

10. The method of claim 0 wherein the additional set of information further comprises an inverted file index.

11. A system comprising:
a. means for receiving a natural language search;
b. means, responsive to the means for receiving, for searching a set of information searchable using the natural language search, the set of information having been generated from a set of structured information which is unsearchable using the natural language search;
c. means for formulating a set of search results; and
d. means for transmitting a signal associated with the set of search results.

12. The system of claim 11 wherein the means for formulating a set of search results comprises a text collection and an inverted file index.
